(19) United States
(12) Patent Application Publication
(10) Pub. No.: US 2020/0333875 A1
(43) Pub. Date: Oct. 22, 2020

(54) METHOD AND APPARATUS FOR INTERRUPT DETECTION

(71) Applicant: SAMSUNG ELECTRONICS CO., LTD., Suwon-si (KR)

(72) Inventors: Mayank BANSAL, Noida (IN); Ayushi MITTAL, Noida (IN); PRIYANSHU, Noida (IN); Sumit KUMAR, Noida (IN); Sugreev PRASAD, Noida (IN)

(73) Assignee: SAMSUNG ELECTRONICS CO., LTD., Suwon-si (KR)

(21) Appl. No.: 16/851,915

(22) Filed: Apr. 17, 2020

(30) Foreign Application Priority Data
Apr. 17, 2019 (IN) 201911015444

(51) Int. Cl. G06F 3/01; G06F 3/16; G06F 9/48; G06F 9/38

(52) U.S. Cl. CPC G06F 3/011; G06F 3/017; G06F 9/3836; G06F 9/4843; G06F 3/167

(57) ABSTRACT

A method of detecting an instruction from a user includes receiving, from the user of a user device, an audio input; extracting a non-verbal audio cue or a verbal audio cue based on the audio input; calculating a confidence score based on the non-verbal audio cue or the verbal audio cue; and detecting the audio input as the instruction based on the confidence score exceeding a predetermined value.

### CROSS-REFERENCE TO RELATED APPLICATION(S)

This application is based on and claims priority under 35 U.S.C. § 119 to Indian Patent Application No. 201911015444, filed on Apr. 17, 2019, in the Indian Intellectual Property Office, the disclosure of which is incorporated by reference herein in its entirety.

### BACKGROUND

### 1. Field

The disclosure relates generally to virtual assistants. More particularly, the disclosure relates to an apparatus and a method for detecting interrupts.

### 2. Description of Related Art

Virtual assistants are voice-controlled applications integrated into portable devices such as smart speakers, smartphones, and laptops. The virtual assistants are generally used for playing music, reading news, answering general questions, setting alarms and timers, and controlling network-connected devices. The virtual assistants are usually activated by recognizing a word or a phrase generated by a user. The virtual assistants may analyze instructions given by the user in a natural language, and provide output in a human-recognizable form that can be easily comprehended by the user. Additionally, the virtual assistants are also enabled to perform tasks dictated by the user.

FIG. 1 illustrates an interaction between a user and a virtual assistant. Referring to FIG. 1, the user activates the virtual assistant by using a phrase “Hey, assistant” in operation 101. When the virtual assistant detects that the user utters “Hey, assistant”, the virtual assistant is activated. In operation 103, the user commands the virtual assistant to book a cab with an utterance of “Book a Cab for Manhattan mall, 100 West 33^{rd} street.” In response, the virtual assistant executes the task of booking the cab as instructed by the user and thereafter, provides an audio output to the user to indicate that the task of booking the cab has been executed successfully in operation 105.

Hence, the virtual assistants might only be capable of being activated by certain predefined words or phrases.

However, the abovementioned virtual assistant system does not consider the interruptions initiated by the user.

Therefore, there is a need for an efficient virtual assistant system that intelligently detects the interruptions and the commands provided by the user without misinterpreting the user's speech.

### SUMMARY

This summary is provided to introduce concepts related to apparatuses and methods for interrupt detection. This summary is not intended to identify essential features of the disclosure or intended for use in determining or limiting the scope of the disclosure.

Additional aspects will be set forth in part in the description which follows and, in part, will be apparent from the description, or may be learned by practice of the presented embodiments.

According to an aspect of an example embodiment, a method of detecting an instruction from a user includes receiving, from the user of a user device, an audio input; extracting a non-verbal audio cue or a verbal audio cue based on the audio input; calculating a confidence score based on the non-verbal audio cue or the verbal audio cue; and detecting the audio input as the instruction based on the confidence score exceeding a predetermined value.

The non-verbal audio cue includes at least one of a pitch of the audio input, an intensity of the audio input, an abrupt change in the intensity of the audio input, or an intensity localization of the audio input.

The verbal audio cue includes at least one of a word, a sentence, a context of the word or the sentence, or a meaning of the word or the sentence.

The method includes receiving a video input; extracting a video cue based on the video input; calculating the confidence score based on the video cue; and detecting the audio input or the video input as the instruction based on the confidence score exceeding the predetermined value.

The video cue includes at least one of a gesture of the user, a movement of the user, an attentiveness of the user, an eye gaze of the user, a distance between the user and the user device, or a presence of another user in a vicinity of the user device.

The method includes executing a task corresponding to the instruction.

The method includes receiving a second audio input during execution of the task; extracting a second non-verbal audio cue or a second verbal audio cue based on the second audio input; determining that the instruction is an intentional instruction based on the second non-verbal audio cue or the second verbal audio cue; and updating the confidence score based on determining that the instruction is the intentional instruction.

The method includes detecting a plurality of audio inputs from a plurality of users; extracting a plurality of verbal audio cues or a plurality of non-verbal audio data corresponding to each of the plurality of users; calculating a plurality of confidence scores corresponding to the each of the plurality of users; and detecting a plurality of instructions corresponding to the plurality of confidence scores.

The method includes allocating respective priorities to the plurality of instructions; and executing a plurality of tasks corresponding to the plurality of instructions based on the respective priorities.

The method includes extracting verbal information from the audio input; determining a context of the verbal information; and transmitting the context of the verbal information as the verbal audio cue.

According to an aspect of an example embodiment, an apparatus for detecting an instruction from a user includes a sensor configured to receive, from a user, an audio input; and a processor configured to extract a non-verbal audio cue or a verbal audio cue based on the audio input; calculate a confidence score based on the non-verbal audio cue or the verbal audio cue; and detect the audio input as the instruction when the confidence score exceeds a predetermined value.

The non-verbal audio cue includes at least one of a pitch of the audio input, an intensity of the audio input, an abrupt change in the intensity of the audio input, or an intensity localization of the audio input.

The verbal audio cue includes at least one of a word, a sentence, a context of the word or the sentence, or a meaning of the word or the sentence.

The apparatus includes a second sensor configured to receive a video input from the user. The processor is further configured to extract a video cue based on the video input; calculate the confidence score based on the video cue; and detect the audio input or the video input as the instruction based on the confidence score exceeding the predetermined value.

The video cue includes at least one of a gesture of the user, a movement of the user, an attentiveness of the user, an eye gaze of the user, a distance between the user and the apparatus, or a presence of another user in a vicinity of the apparatus.

The processor is further configured to execute a task corresponding to the instruction.

The sensor is further configured to receive a second audio input during execution of the task, and the processor is further configured to extract a second non-verbal audio cue or a second verbal audio cue based on the second audio input; determine that the instruction is an intentional instruction based on the second non-verbal audio cue or the second verbal audio cue; and update the confidence score based on determining that the instruction is the intentional instruction.

The sensor is further configured to detect a plurality of audio inputs from a plurality of users; extract a plurality of verbal audio cues or a plurality of non-verbal audio cues corresponding to each of the plurality of users; calculate a plurality of confidence scores corresponding to the each of the plurality of users; and detect a plurality of instructions corresponding to the plurality of confidence scores.

The processor is further configured to allocate respective priorities to the plurality of instructions; and execute a plurality of tasks corresponding to the plurality of instructions based on the respective priorities.

The processor is further configured to extract verbal information from the audio input; determine a context of the verbal information; and transmit the context of the verbal information as the verbal audio cue.

### BRIEF DESCRIPTION OF ACCOMPANYING DRAWINGS

The above and other aspects, features, and advantages of certain embodiments of the present disclosure will be more apparent from the following description taken in conjunction with the accompanying drawings, in which:

FIG. 1 illustrates an interaction between a user and a virtual assistant according to an embodiment;

FIG. 2 illustrates an interaction between a user and a virtual assistant according to an embodiment;

FIG. 3A and FIG. 3B illustrate interactions between a user and a virtual assistant, according to an embodiment;

FIG. 4 is a block diagram of an interruption detection environment, according to an embodiment;

FIG. 5 is a block diagram of an interruption detection system, according to an embodiment;

FIG. 6 is a block diagram of a user device, according to an embodiment;

FIG. 7 is a block diagram of a processor, according to an embodiment;

FIG. 8 is a block diagram of a non-verbal cues generation module, according to an embodiment;

FIG. 9 is a block diagram of a verbal cues generation module, according to an embodiment;

FIG. 10A is a block diagram of a confidence score calculator module, according to an embodiment;

FIG. 10B illustrates a regression model for calculating a confidence score, according to an embodiment;

FIG. 10C illustrates another regression model for calculating a confidence score, according to an embodiment;

FIG. 11 is a block diagram of a feedback module, according to an embodiment;

FIG. 12 illustrates a flowchart for recognizing gestures, according to an embodiment;

FIG. 13A, FIG. 13B, and FIG. 13C are flowcharts illustrating a method for attention detection, according to an embodiment;

FIG. 14 is a flowchart illustrating a method for generating context score, according to an embodiment;

FIG. 15 is a flowchart illustrating a method for determining context, according to an embodiment;

FIG. 16 is a flowchart illustrating a method for calculating confidence score and providing feedback, according to an embodiment;

FIG. 17 illustrate interactions between a user and a virtual assistant, according to an embodiment;

FIG. 18 illustrates interactions between a user and a virtual assistant, according to an embodiment;

FIGS. 19A and 19B illustrate interactions between a user and a virtual assistant, according to an embodiment;

FIG. 20 is a sequence diagram illustrating interactions between a plurality of users and a virtual assistant according to an embodiment;

FIG. 21 illustrates interactions between a user and a virtual assistant, according to an embodiment;

FIG. 22 illustrates interactions between a user and a virtual assistant, according to an embodiment;

FIG. 23A, FIG. 23B, and FIG. 23C illustrate interactions between a user and a virtual assistant, according to an embodiment.

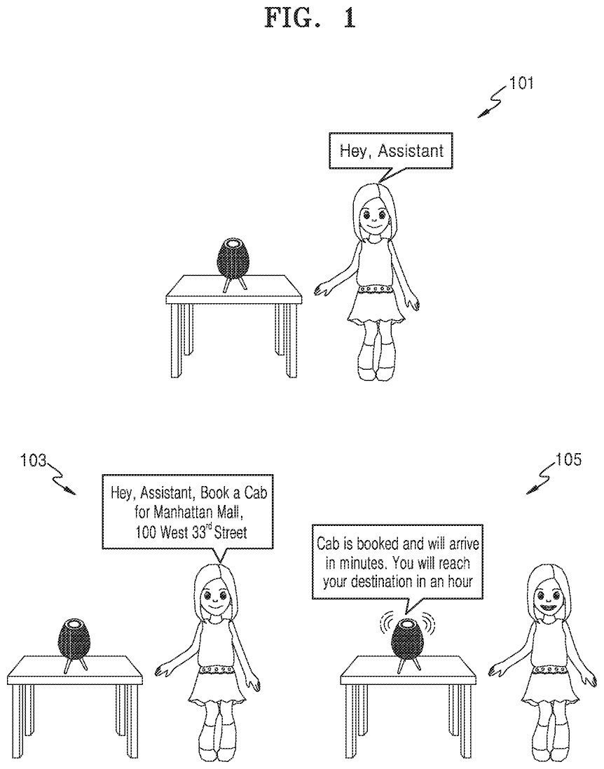

It should be appreciated by those skilled in the art that any block diagrams herein represent conceptual views of illustrative systems embodying the principles of the disclosure.

Similarly, it will be appreciated that any flowcharts, flow diagrams, and the like, represent various processes that may be implemented by instructions stored in a non-transitory computer-readable medium and executed by a computer or processor, whether or not such computer or processor is explicitly shown.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms “1st,” “first,” “2nd,” “second,” and the like, may describe corresponding components regardless of importance or order and are used to distinguish one component from another without limiting the components. For the purpose of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which this disclosure belongs. The system, methods, and examples provided herein are illustrative only and not intended to be limiting.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms such as “first,” “second,” etc., may be used herein to describe various elements, these elements should not be limited by these terms. These terms are generally only used to distinguish one element from another.

Embodiments of the present disclosure will be described below in detail with reference to the accompanying drawings.

Furthermore, connections between components and/or modules within the drawings are not intended to be limited to direct connections. Rather, these components and modules may be modified, re-formatted, or otherwise changed by intermediary components and modules.

References in the disclosure to “one embodiment” or “an embodiment” mean that a particular feature, structure, characteristic, or function described in connection with the embodiment is included in at least one embodiment of the disclosure. The appearances of the phrase “in one embodiment” in various places in the specification are not necessarily all referring to the same embodiment.

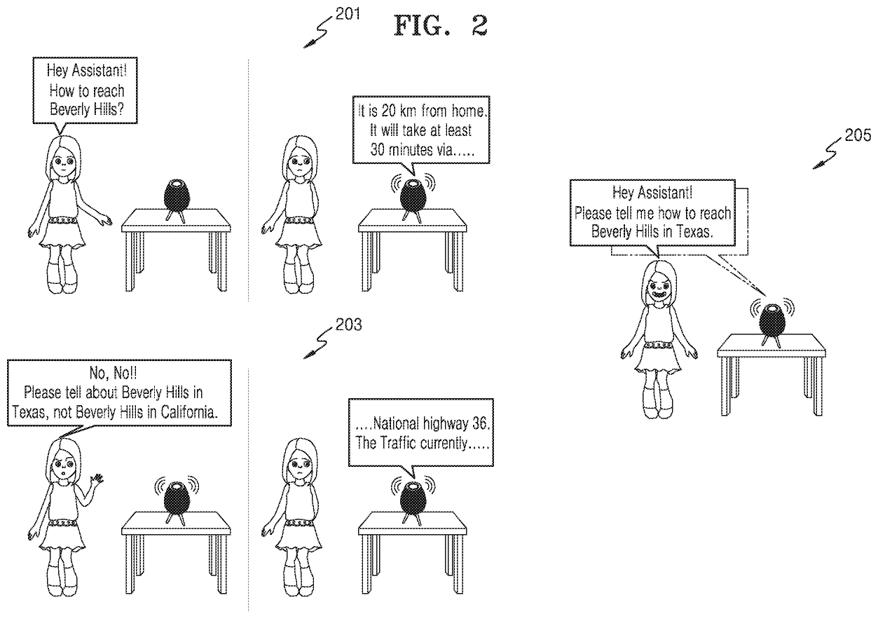

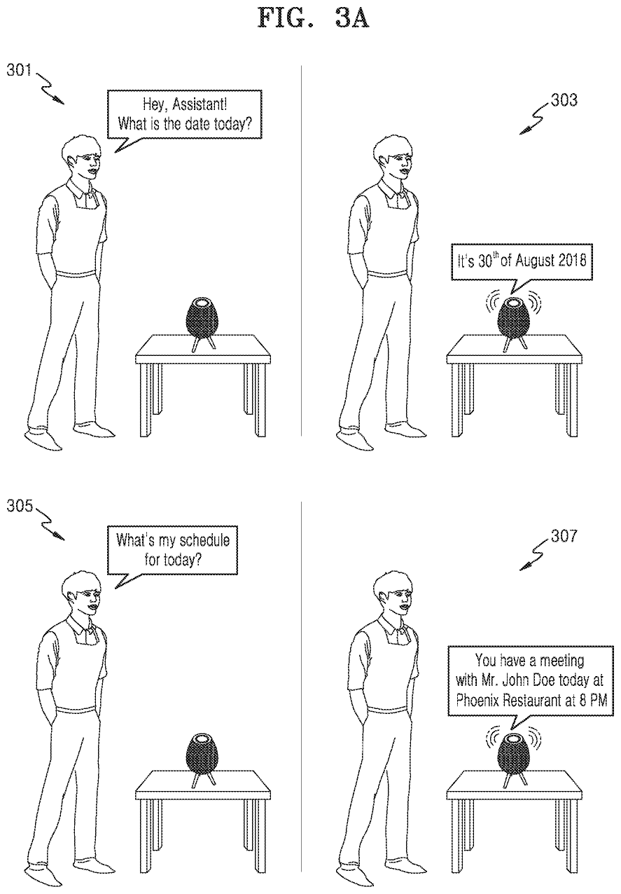

FIG. 2 illustrates an interaction between a user and a virtual assistant. Referring to FIG. 2, the user asks a question to the virtual assistant and the virtual assistant responds to the user in operation 201. In operation 203, the user realizes that the virtual assistant has misinterpreted the question of the user and hence, tries to correct the user's question. However, the virtual assistant continues with the response without acknowledging the user's speech input. In operation 205, the user re-iterates the phrase “Hey, assistant” to stop the virtual assistant's on-going response.

Hence, referring to FIG. 2, the virtual assistant does not respond properly to the user's command while providing a response to a previous query.

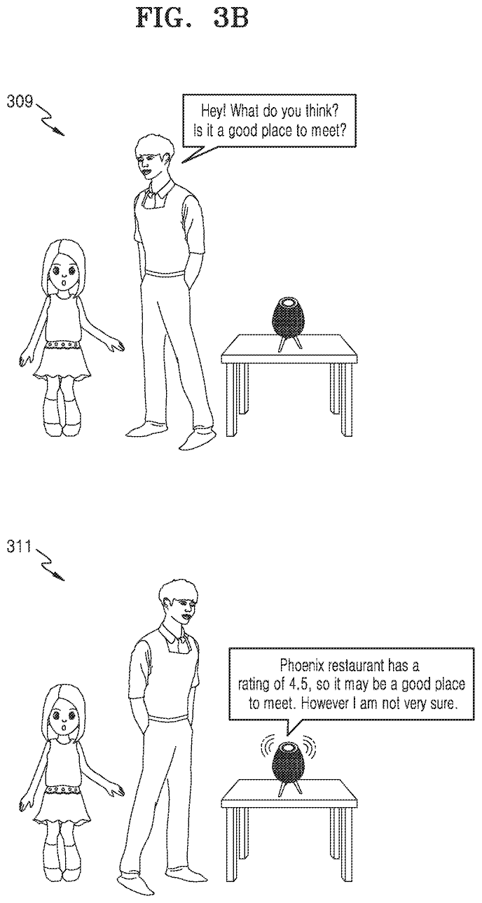

FIG. 3A illustrates an interaction between a user and a virtual assistant, according to an embodiment of the disclosure. Referring to FIG. 3A, the user activates the virtual assistant by the phrase “Hey, assistant,” and asks a first question of “what is the date today?” to the virtual assistant in operation 301. In operation 303, the virtual assistant provides the response to the first question. In operation 305, the user commands the virtual assistant to utter his schedule for that day. In operation 307, the virtual assistant determines the schedule of the user and utters the schedule to the user.

FIG. 3B illustrates an interaction between a user and a virtual assistant, according to an embodiment of the disclosure. In operation 309, the aforementioned user talks to another user in vicinity of the virtual assistant. In operation 311, the virtual assistant recognizes the conversation between the user as a command, which is unintended by the user.

Hence, referring to FIG. 3A and FIG. 3B, the virtual assistant fails to recognize properly the conversations taking place in the vicinity of the virtual assistant.

In a virtual assistant system, the virtual assistant determines whether the user should be interrupted by providing a voice output when an input speech is detected concurrently. The virtual assistant system uses context of the input speech to determine the urgency of the output. The virtual assistant system determines whether the user provides an intended speech input or not.

However, the abovementioned virtual assistant system has difficulties in identifying situations where the speech input might or might not be for the virtual assistant.

In an embodiment, the virtual assistant system determines a priority between various outputs that are to be provided to the user at the same time. The virtual assistant system uses the context of the outputs to determine the urgency of outputs.

However, the abovementioned virtual assistant system does not take into consideration any interruption by the user while the output is being provided to the user.

However, the abovementioned virtual assistant system does not consider the situations where the user might be talking to another user and assumes all the user's speech to be commands intended for the virtual assistant system.

In an embodiment, the virtual assistant system has a control system for providing an output to the user based on a priority and detection of human speech. The virtual assistant system monitors the human conversation and decides if the user can be interrupted or not.

The various embodiments of the disclosure provide a system and a method for interruption detection.

In an embodiment of the disclosure, an interruption detection method is provided. The interruption detection method is executed by an interruption detection system for detecting an interrupt in an on-going conversation between a user device and a user. A processing module receives an audio input signal and a video input signal from the user device. An audio processing module extracts one or more non-verbal audio cues and one or more verbal audio cues based on the audio input signal. A video processing module extracts one or more video cues based on the video input signal. A confidence score calculator module calculates a confidence score based on the non-verbal audio cues, the verbal audio cues, and the video cues. The confidence score calculator module determines at least one of: the audio input signal and the video input signal to be an interrupt for the user device when the calculated confidence score exceeds a predefined threshold confidence score.

In another embodiment of the disclosure, an interruption detection system for detecting an interrupt in an on-going conversation between a user device and a user is provided. The interruption detection system includes a processing module and a confidence score calculator module. The processing module includes an audio processing module and a video processing module. The audio processing module is configured to receive an audio input signal from the user device and extract one or more non-verbal audio cues and verbal audio cues based on the audio input signal. The video processing module is configured to receive a video input signal from the user device and extract one or more video cues based on the video input signal. The confidence score calculator module is configured to calculate a confidence score based on the non-verbal audio cues, the verbal audio cues, and the video cues and determine at least one of: the audio input signal and the video input signal to be an interrupt for the user device when the calculated confidence score exceeds a predefined threshold confidence score.

The non-verbal audio cues are indicative of one or more of: intensity of audio input signal, pitch of the audio input signal, abrupt change in the intensity or the pitch of the audio input signal, and intensity localization of the audio input signal.

The verbal audio cues are indicative of one or more of: one or more words or sentences spoken by the user, context of the words or sentences, and meaning of the words or sentences.

The video cues are indicative of one or more of: gesture made by the user, movement of the user, attentiveness of the user, gaze of the user, distance of the user from the user device, and presence of other users in vicinity of the user device.

The confidence score is indicative of a probability of at least one of: the audio input signal and the video input signal being the interrupt for the user device.

The path planner module determines a task corresponding to the interrupt and executes the task subsequent to detection of the interrupt.

The audio processing module identifies whether the audio input signal includes speeches from a plurality of users. The audio processing module extracts a plurality of verbal and non-verbal audio cues corresponding to each user of the plurality of users. The confidence score calculator module calculates a plurality of confidence scores corresponding to the plurality of users based on the plurality of verbal and non-verbal audio cues and the video cues. The confidence score calculator module determines a plurality of interrupts corresponding to the plurality of users. The processing module assigns one or more priorities to the plurality of interrupts. The path planner module executes a plurality of tasks corresponding to the plurality of interrupts in order of the priorities assigned to the interrupts.

A feedback module receives a second audio input signal and a second video input signal subsequent to the execution of the task. The feedback module extracts one or more secondary non-verbal audio cues and one or more secondary verbal audio cues based on the second audio input signal. The feedback module extracts one or more secondary video cues based on the second video input signal. The feedback module determines whether the detected interrupt is an intentional interrupt by the user for the user device based on the secondary non-verbal audio cues, the secondary verbal audio cues, and the secondary video cues. The feedback module transmits a feedback to the confidence score calculator module based on aforesaid determination. The confidence score calculator module updates the calculated confidence score in real-time based on the received feedback.

A verbal cues generation module extracts verbal information from the audio input signal. A context recognition module determines a context of the verbal information. The audio processing module transmits the context of the verbal information to the confidence score calculator module as the verbal audio cues.

A pre-processing module normalizes the non-verbal audio cues, the verbal audio cues, and the video cues. A weight selection module assigns weights to the normalized non-verbal audio cues, the normalized verbal audio cues, and the normalized video cues. A learning module identifies a scene out of a plurality of predefined scenes based on the weighted non-verbal audio cues, the weighted verbal audio cues, and the weighted video cues. A weight adjustment module modifies the weights assigned to the non-verbal audio cues, the verbal audio cues, and video cues based on the identified scene and the feedback.

A non-verbal learning module determines intensity and pitch of the audio input signal. An intensity abruption detection module detects an abrupt change in intensity of the audio input signal. An intensity localization module determines an intensity localization of the audio input signal.

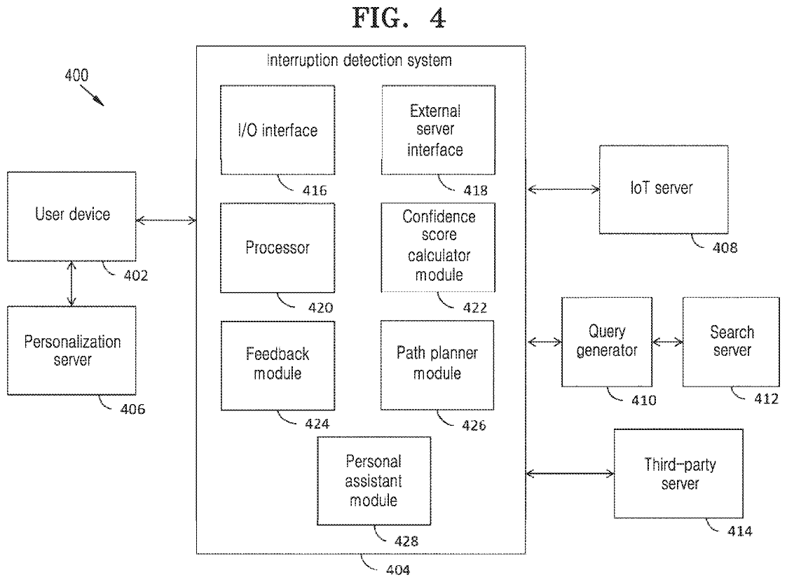

FIG. 4 is a block diagram of an interruption detection environment, according to an embodiment of the disclosure.

Referring to FIG. 4, an interruption detection architecture 400 is shown. The interruption detection architecture 400 includes a user device 402, an interruption detection system 404, a personalization server 406, an Internet of Things (IoT) server 408, a query generator 410, a search server 412, and a third-party server 414. The interruption detection system 404 includes an input/output (I/O) interface 416, an external server interface 418, a processor 420, a confidence score calculator module 422, a feedback module 424, a path planner module 426, and a personal assistant module 428. The interruption detection system 404 may be a standalone device in an embodiment.

The user device 402 may include electronic devices such as smartphones, smart speakers, personal digital assistants, laptops, personal computers, tablet computers, etc. The user device 402 may be in communication with the personalization server 406 and the interruption detection system 404.

In an embodiment, the user device 402 executes a virtual assistant application which is capable of receiving user's speech and executing tasks based on the user's speech. That is, if the user speaks words, phrases, or sentences, the words, phrases or sentences are captured by the user device 402. The virtual assistant application processes the user's speech and executes one or more tasks based on the user's speech. In an embodiment, the user is engaged in an on-going conversation with the virtual assistant of the user device 402. During the on-going conversation between the user and the virtual assistant, the user device 402 captures and transmits an audio input and a video input to the interruption detection system 404. The audio input and the video input may be an audio input signal and a video input signal, respectively. The audio input may include audio information such as words or sentences spoken by the user and captured by the user device 402. The video input includes video information such as a gesture performed by the user of the user device 402, a face of the user, and features extracted from the gesture or the face.

The personalization server 406 stores personal information of the user. For instance, the personalization server 406 stores information identifying the user's email address, name, age, gender, address, profession, etc. The personalization server 406 also stores personalization information of the user. For instance, the personalization server 406 stores the user's preferences for various applications, voice templates of the user, etc.

The interruption detection system 404 is in communication with the user device 402 through I/O interface 416. The interruption detection system 404 receives the audio input signal and the video input signal from the user device 402. In an embodiment, the user device 402 and the interruption detection system 404 may be combined into one hardware device.

The processor 420 receives the audio input and the video input. The processor 420 generates non-verbal audio cues and verbal audio cues based on the audio input signal. The processor 420 also generates video cues based on the video input signal. In an embodiment, the non-verbal audio cues, the verbal audio cues, and the video cues may be non-verbal audio data, verbal audio data, and video data, respectively.

The confidence score calculator module 422 receives the non-verbal audio cues, the verbal audio cues, and the video cues from the processor 420. The confidence score calculator module 422 calculates a confidence score based on the non-verbal audio cues, the verbal audio cues, and the video cues. The confidence score calculator module 422 compares the calculated confidence score with a predetermined value such as a predefined threshold confidence score. When the calculated confidence score exceeds the predefined threshold confidence score, the confidence score calculator module 422 determines that at least one of the non-verbal audio cues, the verbal audio cues, and the video cues is an interrupt event for the virtual assistant. The feedback module 424 provides feedback to the confidence score calculator module 422 that facilitates real-time training of the confidence score calculator module 422 which improves accuracy in calculating the confidence score. The confidence score calculator module 422 receives the feedback from the feedback module 424 and updates the calculated confidence score in real-time based on the received feedback.

The path planner module 426 determines one or more paths of responses to be provided to the virtual assistant based on the user's speech.

The interruption detection system 404 transmits a query to the query generator 410. The query generator 410 formulates a searchable query and transmits the searchable query to the search server 412. The search server 412 searches for results corresponding to the query and provides the results to the interruption detection system 404.

The external server interface 418 enables the interruption detection system 404 to interface with external servers, such as the IoT server 408 and the third-party server 414. The IoT server 408 facilitates the user device 402 to control one or more IoT enabled devices connected to the user device 402. The third-party server 414 facilitates accesses to third-party applications and services by the user device 402 through the interruption detection system 404.

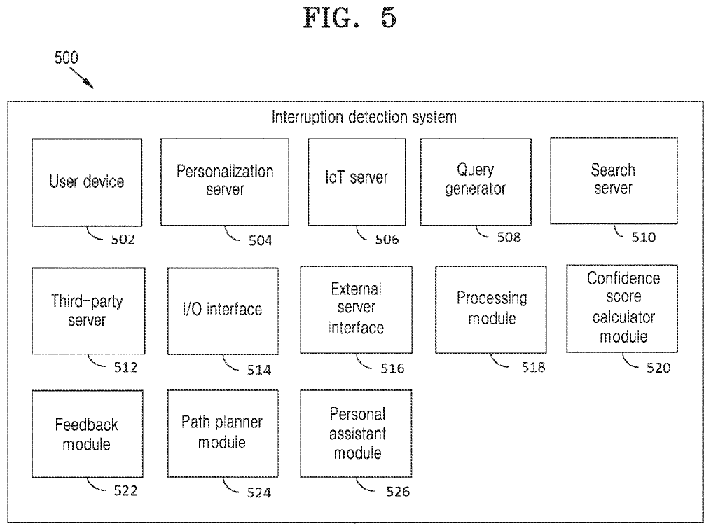

FIG. 5 is a block diagram of an interruption detection system, according to an embodiment of the disclosure.

Referring to FIG. 5, the interruption detection system 500 may include a user device 502, a personalization server 504, an IoT server 506, a query generator 508, a search server 510, a third-party server 512, an I/O interface 514, an external server interface 516, a processing module 518, confidence score calculator module 520, a feedback module 522, a path planner module 524, and a personal assistant module 526. The modules, interfaces and the query generator in the interruption detection system may be implemented as at least one hardware processor.

In an embodiment, the interruption detection system 500 is functionally similar to the interruption detection architecture 400.

In another embodiment, the interruption detection system 500 may operate as a stand-alone system for detection of interrupts.

In another embodiment, the block diagram of the interruption detection system 500 shown in FIG. 5 may be an on-device architecture for detecting interrupts.

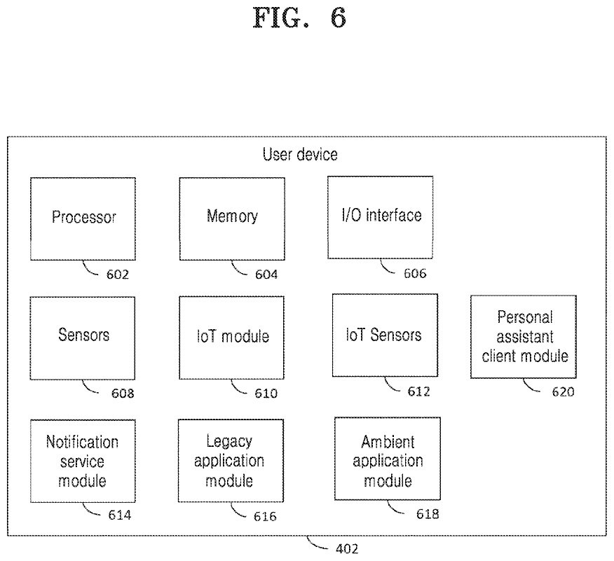

FIG. 6 is a block diagram of a user device, according to an embodiment of the disclosure.

Referring to FIG. 6, the user device 402 may include a processor 602, a memory 604, an I/O interface 606, a plurality of sensors 608, an IoT module 610, a plurality of IoT sensors 612, a notification service module 614, a legacy application module 616, an ambient application module 618, and a personal assistant client module 620. The various modules in the user device 402 may be implemented as at least one hardware processor.

The processor 602 executes one or more executable instructions stored in the memory 604. The I/O interface 606 interfaces the user device 402 with the interruption detection system 404. The IoT module 610 controls the IoT devices connected to the user device 402. The IoT sensors 612 communicate with the IoT devices connected to the user device 402. The notification service module 614 provides alerts and notifications to the user. The legacy application module 616 executes pre-installed applications that are installed on the user device 402 during initialization. The ambient application module 618 executes other applications installed by the user on the user device 402.

The sensors 608 may include at least one of a microphone, a camera, an ambient light sensor, a proximity sensor, a touch sensor, a tilt sensor, and a touch sensor. The sensors 608 capture the audio input with the microphone and the video input with the camera.

The personal assistant client module 620 executes the virtual assistant application on the user device 402. The virtual assistant application assists the user by way of a conversation with the user. In an example, the personal assistant client module 620 receives the audio input and video input detected by the sensors 608 and determines the words or sentences spoken by the user. Based on the detected words or sentences, the personal assistant client module 620 activates the path planner module 426 to execute one or more tasks. In another example, the personal assistant client module 620 transmits the audio input and video input to the interruption detection system 404. The interruption detection system 404 determines the words or sentences spoken by the user, identifies one or more tasks corresponding to the detected words or sentences, and transmits the words or sentences to the user device 402. The personal assistant client module 620 activates the path planner module 426 to execute the identified tasks.

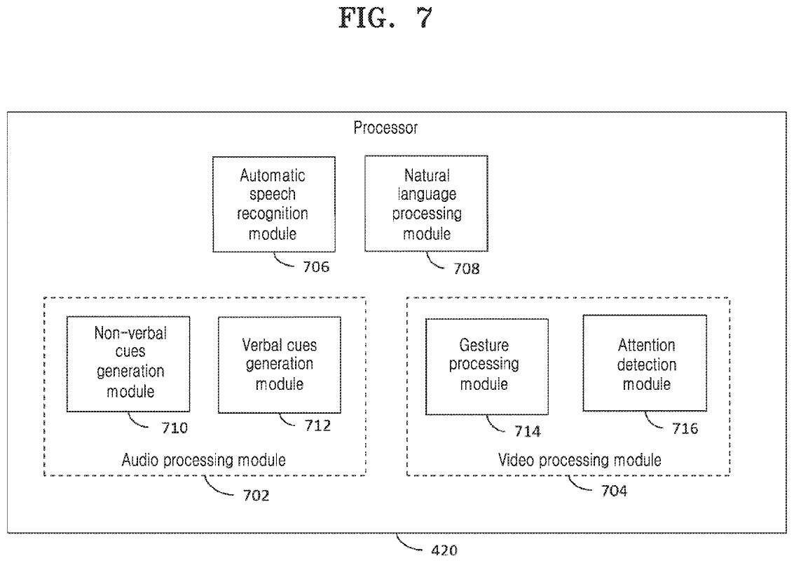

FIG. 7 is a block diagram of a processor, according to an embodiment of the disclosure.

Referring to FIG. 7, the processor 420 includes an audio processing module 702, a video processing module 704, an automatic speech recognition module 706, and a natural language processing module 708. The audio processing module 702 includes a non-verbal cues generation module 710 and a verbal cues generation module 712. The video processing module 704 includes a gesture processing module 714 and an attention detection module 716.

The automatic speech recognition module 706 receives the audio input and converts the audio input into machine readable text data.

The natural language processing module 708 receives the text data and determines language of the text data and/or context of the text data.

The audio processing module 702 receives the audio input. The non-verbal audio cues generation module 702 extracts non-verbal audio cues from the audio input. The non-verbal audio cues may be also referred to as non-verbal audio data. The non-verbal audio cues include intensity of the audio input, pitch, rate, quality, intonation of the audio input, an abrupt change in the intensity or the pitch of the audio input, and intensity localization of the audio input. The non-verbal audio cues vary when the user intends to interrupt the on-going conversation with the virtual assistant and when the user does not intend to interrupt the on-going conversation with the virtual assistant. For instance, the intensity localization includes learning the intensity of the user's voice when a user tries to interrupt the on-going conversation with the virtual assistant at different positions with respect to the user device 402 over time. In another example, an abrupt increase in the intensity of the audio input signal may indicate that the user intends to interrupt the on-going conversation with the voice assistant. In another example, the intensity of the audio input may decrease when the user is talking to another user and not to the virtual assistant. Hence, the non-verbal audio cues are useful in determining whether the words or sentences spoken by the user are an interrupt in the on-going conversation between the user and the virtual assistant.

The verbal cues generation module 712 receives the audio input. The verbal cues generation module 712 extracts the verbal audio cues based on the audio input. The verbal audio cues include the words or sentences spoken by the user, context of the words or sentences, and meanings of the words or sentences. For example, when the context of the words or sentences is irrelevant to the context of the on-going conversation between the user and the virtual assistant, it is likely that the aforementioned words or sentences are not an interrupt in the on-going conversation between the user and the virtual assistant. Hence, the verbal audio cues are useful in determining whether the words or sentences spoken by the user are an interrupt in the on-going conversation between the user and the virtual assistant.

The video processing module 704 receives the video input. The video input includes multiple frames. The video processing module 704 processes the frames to extract the video cues from the video input. The video cues include gestures made by the user, movements of the user, attentiveness of the user, gaze of the user, a distance of the user from the user device 402, and a presence of other users in vicinity of the user device 402. The video cues may be also referred to as video data.

The gesture processing module 714 determines one or more gestures of the user. The gesture processing module 714 compares the detected gestures with a set of predefined gestures stored in a memory of the interruption detection system 404. For instance, when the user is pointing towards or looking at the user device 402 while speaking, it is detected that the user intends to interrupt the on-going conversation with the virtual assistant. The gesture processing module 714 also determines whether there is a presence of other users along with the user in the vicinity of the user device 402. For instance, when the user is looking at another user and talking, it is determined that the user does not intend to interrupt the on-going conversation with the virtual assistant. The gesture processing module 714 also determines other video cues such as the distance of the user form the user device 402, ambience, and location. The gesture processing module 714 also determines which gestures are relevant to which scenes. For instance, when the user is driving a car, hand gestures like scroll and swipe are relevant to controlling car music. In another example, when the user is expected to reply with an affirmative or a negative, the head gestures are relevant. If the gesture processing module 714 identifies a relevant gesture, the probability of the gesture being an interrupt increases, and hence, the confidence score increases.

In an embodiment, the gesture processing module 714 performs gesture recognition and matching using different image processing or machine learning techniques. The data needed for gesture recognition may be provided by the user device 402 by way of a wearable device or a computer-vision based device. The gesture processing module 714 provides a probability of the video input signal being an interrupt for the virtual assistant.

The attention detection module 716 detects attention of the user. The attention detection module 716 also detects eye gaze, eye gaze movement and facial features of the user. For instance, when it is detected that the user is looking directly at the user device, i.e., the eye gaze of the user is directed towards the user device 402, it is likely that the user interrupts the on-going conversation between the user and the user device.

The attention detection module 716 considers a stream of video frames from the sensors 608 of the user device 402. The attention detection module 716 extracts information from the video frames about face recognition, face orientation, line of sight of the user, the change in expressions of the user, eye gaze behavior, etc. In an example, the attention detection module 716 first recognizes the face of the user and tracks the user's face assuming a little movement. In case the attention detection module 716 loses the track of the user's face, the attention detection module 716 performs face recognition again. The attention detection module 716 uses two-level feature extraction. In frame-level feature extraction, the attention detection module 716 tracks the user's face across multiple frames. In segment-level feature extraction, the attention detection module 716 is trained to classify the features across multiple segments of video frames. The eye gaze behavior recognition is used to extract eye gaze features such as blinking of the eyes and eye fixations by tracking position of pupils of the user's eyes and by using eye landmarks. The feature selection removes redundant features and the relevant features are provided to a classifier. Classifiers based on hidden Markov models, support vector machines (SVMs), neural networks, etc., may be used by the attention detection module 716. The attention detection module 716 calculates a probability of the user being attentive towards the user device 402.

Hence, the video cues are useful in determining whether the words or sentences spoken by the user are an interrupt in the on-going conversation between the user and the virtual assistant.

It will be understood to a person of skill in the art that the disclosure is not limited to the abovementioned non-verbal audio cues, verbal audio cues, and video cues. The examples of the non-verbal audio cues, the verbal audio cues, and the video cues mentioned above are presented merely to explain the functionality of the processor 420.

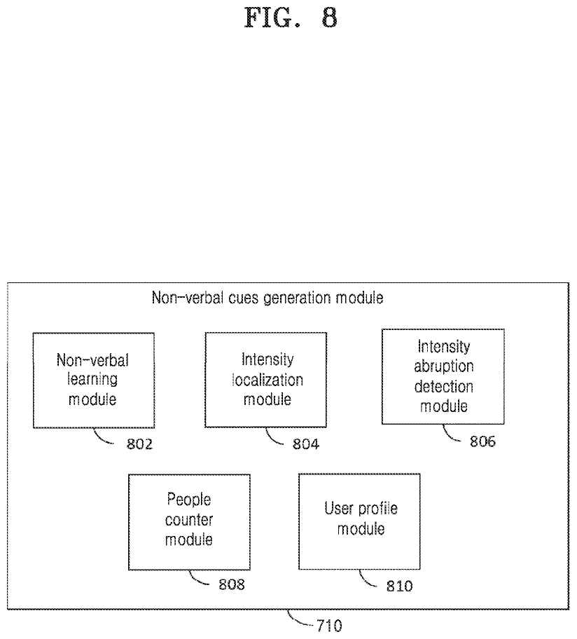

FIG. 8 is a block diagram of a non-verbal cues generation module, according to an embodiment of the disclosure.

Referring to FIG. 8, the non-verbal cues generation module 710 includes a non-verbal learning module 802, an intensity localization module 804, an intensity abruption detection module 806, a people counter module 808, and a user profile module 810.

The non-verbal learning module 802 recognizes and learns useful non-verbal factors, such as, quality, pitch, rate, rhythm, stress, intonation and speaking style extracted from the speech of the user. The factors that contribute to distinguishing an interrupt over a non-interrupt are identified and stored in the memory. After receiving the audio input, the non-verbal learning module 802 extracts the non-verbal audio cues and compares the extracted non-verbal audio cues with the stored contributing factors. The greater the extracted non-verbal audio cues matches with the differentiating factors, the greater is the probability that the audio input is an interrupt.

In an embodiment, the audio input is processed using audio processing techniques suitable for extracting the non-verbal audio cues required for learning. For instance, a distance between zero crossing points of the audio input is used for pitch detection. The learned values of the non-verbal audio cues are then clustered into two sets. A first set contains values of non-verbal audio cues when the user is talking with the virtual assistant. A second set contains values of the non-verbal audio cues when the user's voice is not an audio input or interruption for the virtual assistant. The classification of the non-verbal audio cues into the first set or the second set may be performed by clustering techniques such as k-means clustering. Whenever the user's voice is detected, the aforementioned non-verbal audio cues are calculated, classified and matched with a representative value of the first set. The representative value of the first set may be a mean of the values in the first set. The non-verbal learning module 802 provides an output indicative of a probability of the user's voice being an interrupt for the virtual assistant.

The intensity localization module 804 determines a location of origin of the audio input based on the intensity of the audio input. Generally, it is observed that the intensity of the audio input signal does not change abruptly when the user is interrupting the virtual assistant. The intensity localization module 804 learns the intensity of the user's voice at different location with respect to the user device 402 over time and stores the same in the memory. The intensity localization module 804 compares the intensity localization of the audio input signal with the stored intensity.

In an embodiment, the intensity localization module 804 learns the intensity distribution of user's voice at various locations with respect to the user device 402 over time. The spatial location of the user is used by the learning model. The spatial location of the user may be obtained from the sensors 608. At every location with respect to the user device 402, the intensity values will be classified into two sets. A first set contains sound intensity values at which the user gives input to the virtual assistant. A second set contains sound intensity values at which the user does not provide any input to the virtual assistant or at which the user's voice is not an input for the virtual assistant. The first and second sets may initially contain default values, respectively. The default values may be user-specific or application-specific. The first and second sets may be maintained using clustering algorithms such as k-means clustering. The model trains over time and learns the intensities at which the user provides instructions to the virtual assistant at different locations. When the user's voice is detected, the intensity of the user's voice is matched with the intensities from the user's location to calculate a probability of the user's voice being an input to the virtual assistant.

The intensity abruption detection module 806 detects abrupt changes in the intensity of the audio input signal. It has also been observed that the intensity of the user's voice does not change drastically when the location of the user is constant. Hence, the change in the intensity of the user's voice is very small and is within a limited range. The intensity abruption detection module 806 uses the aforesaid intensity variation to determine a probability of whether the user's voice is an interrupt for the virtual assistant or not.

In an embodiment, let t=0 be the time when the user initiates the conversation with the virtual assistant using wake words such as “Hey, assistant!.” The audio input is received at time t. The intensity abruption detection module 806 considers all the sound intensities of the audio input signal provided by user to the virtual assistant in a predefined interval before t. The predefined interval may be chosen depending upon the application of the virtual assistant. The intensity abruption detection module 806 detects an abruption in the intensity by checking whether the current intensity, i.e., the intensity of the audio input signal at time t, lies within the range of time weighted standard deviation about the time weighted mean of the intensities in the interval. After the conversation of the user with the virtual assistant begins, the virtual assistant continuously monitors the intensity values of the audio input signal and checks whether the intensity of the audio input signal lies within the range of the time weighted standard deviation about the time weighted mean. If the intensity lies in the aforementioned range, the audio input is determined to be an interrupt for the virtual assistant. The intensity abruption detection module 806 calculates mean and standard deviation as time weighted because the current intensity is expected to be closer to the most recent intensities if the user intends to interrupt the on-going conversation with the virtual assistant. Also, the intensity abruption detection module 806 calculates the mean value of the intensities for a predefined interval instead of all intervals from t=0 because the intensities over longer time before time t during the conversation may not have much relevance with the intensity at time t.

In a multi-user case, the people counter module 808 determines a number of people or users in the vicinity of the user device 402. When there are many people in the vicinity of the user device 402, the chances that the user might talk to someone and not to the virtual assistant increase. Therefore, in order to evaluate that the interruption is directed towards the virtual assistant or it is directed towards other person, detecting the presence of other people may be useful.

The user profile builder module 810 builds a user profile. The user profile builder module 810 recognizes which user is talking with the virtual assistant. This may be helpful in cases where there are multiple interruptions by different users at the same time or within a short time interval. In such a case, the interruption of that user which has a higher priority is processed first. The user priority is decided when the user profile builder module 810 has profiles for each user. The interruptions from low priority users such as kids may be accepted after the instructions from the high priority users are executed or the interruptions from the low priority users may be even ignored. The user profile builder module 810 performs and generates the user profiles for the users.

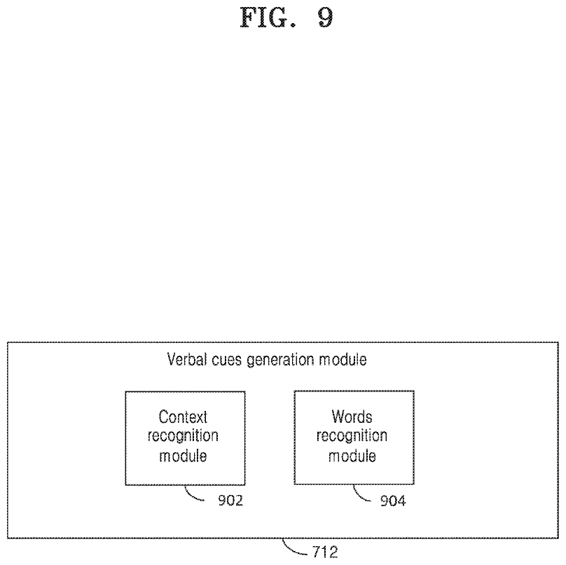

FIG. 9 is a block diagram of a verbal cues generation module, according to an embodiment of the disclosure. Referring to FIG. 9, the verbal cues generation module 712 includes a context recognition module 902 and a words recognition module 904.

The context recognition module 902 determines the context of the words or sentences spoken by the user. The context recognition module 902 also determines the meaning of the words or sentences spoken by the user. The context recognition module 902 determines whether the context of the user's spoken words or sentences matches or is similar to the context of the on-going conversation between the user and the virtual assistant.

The words recognition module 904 recognizes a presence of predetermined words that may be spoken by the user to activate the virtual assistant of the user device 402. The predefined words may also be spoken by the user to explicitly interrupt the on-going conversation between the user and the virtual assistant.

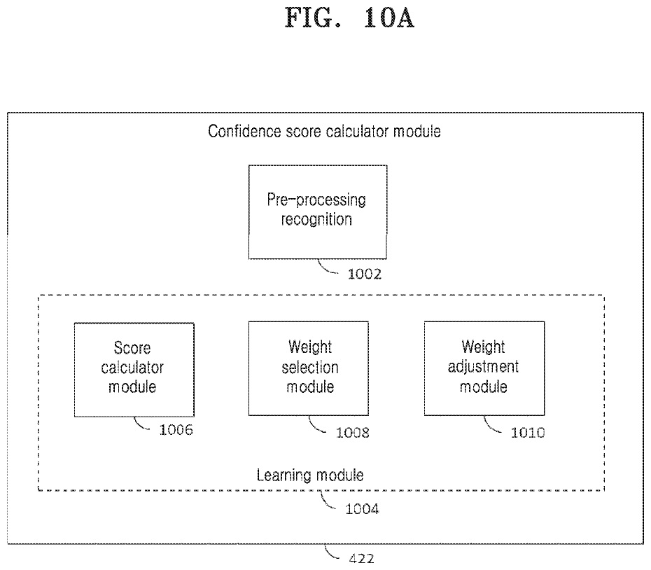

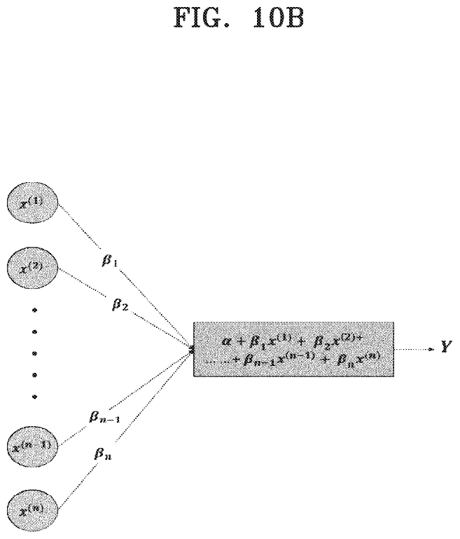

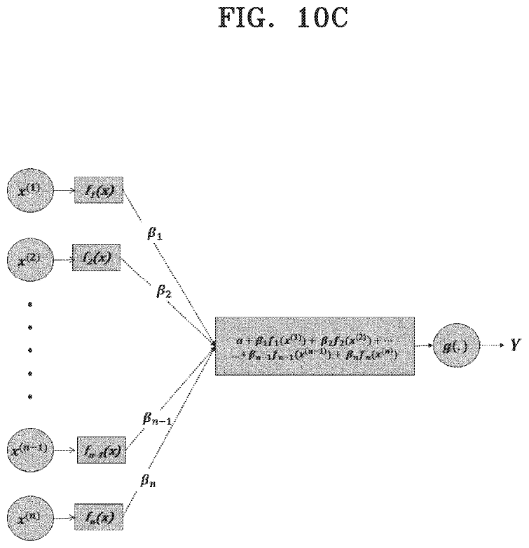

FIG. 10A is a block diagram of a confidence score calculator module, according to an embodiment of the disclosure. Referring to FIG. 10, the confidence score calculator module 422 includes a pre-processing module 1002 and a learning module 1004. The learning module 1004 includes a score calculator module 1006, a weight selection module 1008, and a weight adjustment module 1010.

The pre-processing module 1002 receives the non-verbal audio cues, the verbal audio cues, and the video cues and normalizes the non-verbal audio cues, the verbal audio cues, and the video cues. For instance, the pre-processing module 1002 converts the non-verbal audio cues, the verbal audio cues, and the video cues into a predefined range that is common for all the cues. This improves the efficiency and eases the calculations performed by the confidence score calculator module 422. The normalized non-verbal audio cues, the normalized verbal audio cues, and the normalized video cues are provided to the learning module 1004.

In machine learning, data preprocessing might be needed to obtain clean data from unformatted real-world data. For a better model, it might be necessary to provide equity among all inputs. Some of the preprocessing methods include scaling, normalization, standardization, dimensionality reduction, etc. For instance, if an input A with ranges from 0 to 1 is compared with an input B with ranges from 0 to 100, a value 0.9 in input A is much more significant than a value 0.9 in input B. This problem may be overcome by scaling one of the inputs to the range of other inputs. In case of multiple inputs, normalization or standardization may also be performed to bring all the inputs into the same range. For the confidence score calculator module 422, since the input is received from different sources, normalization may be suitable for pre-processing. However, the pre-processing techniques also depend on the algorithm used. For instance, null values may be excluded if the random forest algorithm is used. Sometimes, the pre-processing technique may also depend on the type of application of the virtual assistant.

The learning module 1004 learns the user's behavior in different scenes. It is observed that the user's behavior changes and that the user behaves differently in different scenes. The learning module 1004 determines the scene based on the application in which the virtual assistant is used. The learning module 1004 uses multivariate regression to calculate the confidence score. The confidence score can be classified into several ranges. For instance, the confidence score can be classified into ranges such as “interruption,” “user's action required,” and “not an interruption.” In the “interruption” range, the learning module 1004 determines that an interrupt has occurred. In the “user's action required” range, the learning module 1004 may classify an input into the interrupt but require additional input from the user to confirm an occurrence of the interrupt. In “not an interrupt” range, the learning module 1004 determines that no interrupt has occurred.

Hence, the learning module 1004 may learn the user's behavior according to the scene around the virtual assistant. For this, the learning module 1004 learns the user's way of giving inputs in different scenes over time. This makes the learning module 1004 more robust and user-specific. The learning module 1004 initially uses the pre-processed data to identify the scene around virtual assistant. For instance, for home assistants, factors contributing to the scene may be the user, time of the day, the user's current task, people present around the user, etc. The learning module 1004 considers every scene to be composed of N factors where each scene can be described by a unique combination of values corresponding to these factors. The confidence score calculation depends on the analyzed scene.

The weight selection module 1008 assigns weights to the normalized non-verbal audio cues, the normalized verbal audio cues, and the normalized video cues. In an example, the weight selection module 1008 assigns weights to the normalized non-verbal audio cues, the normalized verbal audio cues, and the normalized video cues based on the scene identified by the learning module 1004. For instance, when the scene of an office working space is identified, the verbal audio cues may be assigned more weight than the video cues. In another example, when the scene of a party is identified, the video cues may be assigned more weight than the verbal audio cues.

In an embodiment, the weight selection module 1008 receives data from the pre-processing module 1002 and builds a scene. The weight selection module 1008 refers to a distance metric which is defined to calculate closeness between the current scene and the scenes encountered previously. The least distance is chosen and compared with a threshold distance value. If the chosen distance is greater than the threshold distance value, then a new scene is introduced among the stored scenes and initialized with default weights. Otherwise, the current scene is categorized into the scene from which it is closest, and weights corresponding to the closest scene are used for the current input. These weights are then sent to the score calculator module 1006.

The score calculator module 1006 calculates the confidence score based on the weighted non-verbal audio cues, the weighted verbal audio cues, and the weighted video cues. The weight adjustment module 1010 receives feedback from the feedback module 424 and adjusts the weights assigned to the normalized non-verbal audio cues, the normalized verbal audio cues, and the normalized video cues based on the received feedback. The weight-adjusted non-verbal audio cues, the weight-adjusted verbal audio cues, and the weight-adjusted video cues are provided to the score calculator module 1006 that updates the calculated confidence score based on the adjusted weights of the cues.

Thereafter, the confidence score calculator module 422 compares the calculated confidence score with a predetermined threshold confidence score. When the calculated confidence score exceeds the predetermined threshold confidence score, the confidence score calculator module 422 determines that at least one of the audio input and the video input is an interrupt by the user in the on-going conversation between the user and the virtual assistant. When the occurrence of the interrupt is detected, the path planner module 426 determines a task corresponding to the detected interrupt and executes the task.

FIG. 10B illustrates a regression model for calculating a confidence score, according to an embodiment of the disclosure.

The Equation (1) represents confidence score in terms of independent variables:

Y=α+β₁x⁽¹⁾+β₂x⁽²⁾⁺ . . . +βₙ₋₁x⁽ⁿ⁻¹⁾+βₙx⁽ⁿ⁾ Equation (1)

### Where:

Y is the confidence score.
x⁽ⁱ⁾ is pre-processed input to the model obtained from output of different modules such as the gesture processing module 714, the attention detection module 716, etc.
βᵢ is the corresponding weight given to each module/factor and α is the bias.

Based on this weight, the interruption detection system 404 provides the confidence score to indicate if the instruction is an interruption or not.

FIG. 10C illustrates another regression model for calculating a confidence score, according to an embodiment of the disclosure. In the example introduced referring to FIG. 10B, it is assumed the data is linearly separable. For non-linearly separable data, non-linearity is introduced to the model and update the Equation (1) into Equation (2) as follows:

Y=g{α+β₁f₁(x⁽¹⁾)+β₂f₂(x⁽²⁾)+ . . . +βₙ₋₁fₙ₋₁(x⁽ⁿ⁻¹⁾)+βₙfₙ(x⁽ⁿ⁾)} Equation (2)

Where, fᵢ(.) and gᵢ(.) are non-linear functions.

After receiving feedback from the feedback module 424, the weight adjustment module 1010 updates the weights. The updated weights are provided to the weight selection module 1008 and updated for the corresponding scene.

One of the ways to update weights is to use a gradient descent algorithm. Since the confidence score denotes the probability of the instruction being an interruption, the actual value of the confidence score should be 1.0 in case of interruption and the actual value of the confidence score should be 0.0 in case of a non-interruption. The weight adjustment module 1010 first calculates errors by using a cost function. The cost function can be chosen depending upon the application in which the virtual assistant is using. One of the cost functions which can be used is given as follows:

$$E ( α , {β}_{1} , {β}_{2} , … {β}_{n - 1} , {β}_{n} ) = \frac{1}{2 m} {\sum }_{i = 1}^{m} {\hat{y}}_{i} - {Y}_{i}^{2} \qquad Equation ( 3 )$$

Where, Yᵢ is the predicted output of the model for i^{th} input, ŷᵢ is the actual output for i^{th} input, which is 1.0 in case of an interruption and 0.0 in case of a non-interruption.

In the initialization mode, ‘m’ is the number of data points as a training is done using labeled data and the number of training examples is known.

During the working mode, since only one input comes at one time, the value of m is 1.

Now, the weight adjustment module 1010 trains to minimize the error and updates the weights using appropriate techniques. If the gradient descent technique is used, the weight update formula is given as Equation (4) below:

β:=β−η∇E Equation (4)

Where ∇E denotes the gradient of cost function.

In an embodiment, the confidence score calculator module 422 operates in two modes which are the initialization mode and the working mode.

In the initialization mode, the confidence score calculator module 422 initializes the weights that are used to calculate the confidence score initially when the interruption detection system 404 is not trained or is trained with only fixed data gathered from the virtual assistant. The initialization values of the weights correspond to the importance of each factor in general. For instance, the context may be given more weight than other factors. The confidence score calculated in this mode is used only for training purposes by the confidence score calculator module 422. In the initialization mode, the confidence score is calculated but the path planner module 426 does not execute any tasks based on the initial confidence score. Hence, the initial working of the virtual assistant is the same as if the virtual assistant does not use any confidence scores. Thereafter, using the user's response, the feedback module 424 decides whether the user's response was an interruption for the virtual assistant. Based on the feedback provided by the feedback module 424 and the calculated confidence score, the weights are adjusted to bring the confidence score in a desired range. The aforementioned process is continued until the interruption detection system 404 achieves accuracy and the calculated confidence score matches with the user's requirement.

In the working mode, the confidence score calculator module 422 has a good level of accuracy. The interruption detection system 404 has now learned the weights according to user's requirement. Hence, the interruption detection system 404 is ready to provide the calculated confidence score. The calculated confidence score is used to determine whether the user's voice was an interruption and to execute tasks accordingly. The feedback from the user is received using the feedback module 424 and the weights are adjusted accordingly.

In case of dependent factors, an output of one factor is used as an input for the second factor. In such cases, the input for the dependent factor can be calculated once the output of the deciding factor is evaluated. Considering that x⁽²⁾ depends on x¹ as follows:

x²(t)=f(x¹(t−1)) Equation (5)

The Equation (1) for confidence score calculation becomes:

Yᵢ=α+β₁xᵢ⁽¹⁾(t)+β₂f(xᵢ⁽¹⁾(t−1))+ . . . +βₙ₋₁xᵢⁿ⁻¹+βₙxᵢⁿ Equation (6)

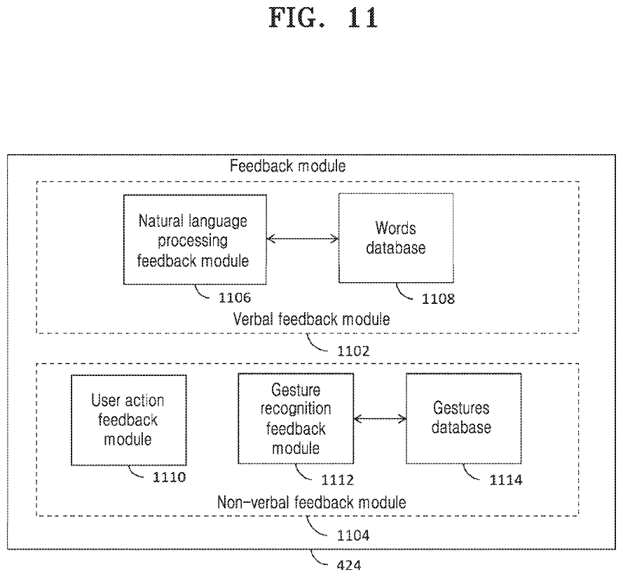

FIG. 11 is a block diagram of a feedback module, according to an embodiment of the disclosure. Referring to FIG. 11, the feedback module 424 includes verbal feedback module 1102 and non-verbal feedback module 1104.

Based on the determination of the interrupt, the feedback module 424 receives another audio input and another video input from the user device 402.

The non-verbal feedback module 1104 receives the audio input and extracts the non-verbal audio cues to determine whether the detected interrupt was indeed an interrupt intended by the user. The user action feedback module 1110 detects a user action after execution of the task. Also, the gesture recognition feedback module 1112 detects the user's gestures after an execution of the task and compares the detected gestures with gestures stored in a gestures database 1114.

The verbal feedback module 1102 receives the audio input and extracts the verbal audio cues to determine whether the detected interrupt was indeed an interrupt intended by the user. The natural language processing feedback module 1106 detects the context and the meaning of the words or sentences spoken by the user after the execution of the task, based on the words database 1108.

The feedback module 424 provides a feedback to the confidence score calculator module 422 to indicate whether the detected interrupt was an interrupt intended by the user.

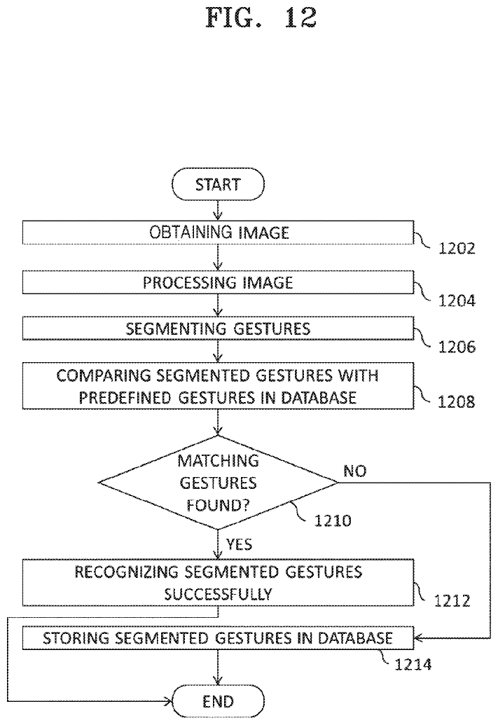

FIG. 12 illustrates a flowchart for recognizing gestures, according to an embodiment of the disclosure.

At operation 1202, gesture processing module 714 acquires an image obtained by the user device 402. At operation 1204, the gesture processing module 714 processes the image to identify the gestures of the user. At operation 1206, the gesture processing module 714 segments the gestures. At operation 1208, the gesture processing module 714 compares the segmented gestures with the predefined gestures stored in a database. At operation 1210, the gesture processing module 714 determines whether or not there are matching gestures in the database. At operation 1210, if the gesture processing module 714 finds matching gestures in the database, the gesture processing module 714 proceeds to the operation 1212. At operation 1212, the gesture processing module 714 successfully recognizes the matching gestures in the database. At operation 1210, if the gesture processing module 714 does not find matching gestures in the database, the gesture processing module 714 proceeds to the step 1214. At operation 1214, the gesture processing module 714 stores the segmented gestures in the database.

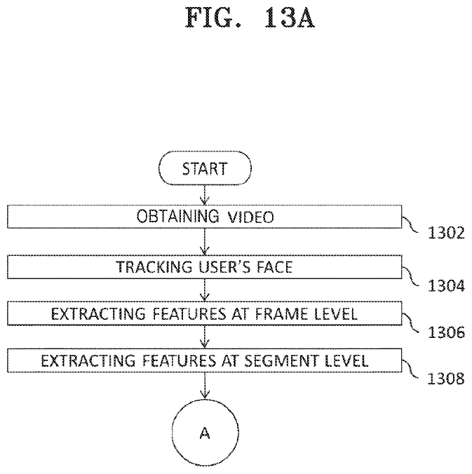

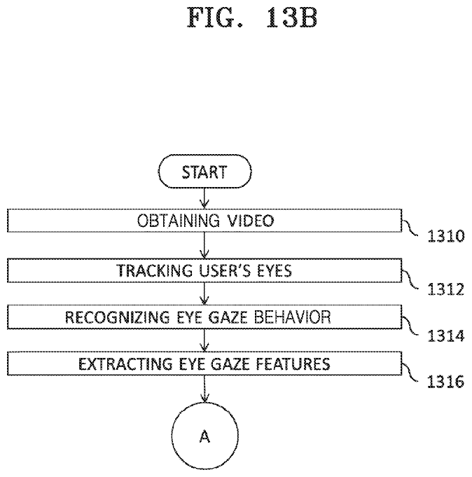

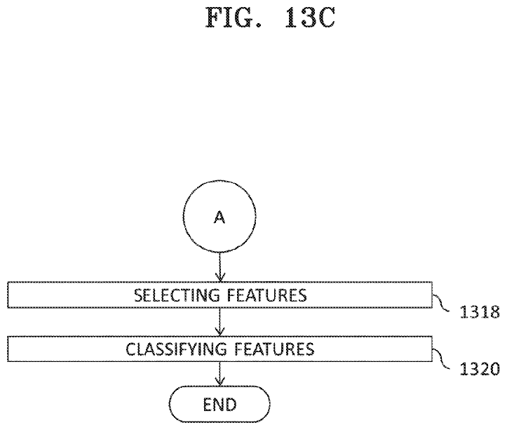

FIG. 13A, FIG. 13B, and FIG. 13C are flowcharts illustrating a method for attention detection, according to an embodiment of the disclosure.

Referring to FIG. 13A, at operation 1302, the gesture processing module 714 obtains the video images—the video input—captured by the user device 402. At operation 1304, the gesture processing module 714 tracks the user's face. At operation 1306, the gesture processing module 714 extracts features from the video input on a frame-level basis. At operation 1308, the gesture processing module 714 extract features from the video input on a segment-level basis.

Referring to FIG. 13B, at operation 1310, the attention detection module 716 obtains the video images—the video input—captured by the user device 402. At operation 1312, the attention detection module 716 tracks the user's eyes. At operation 1314, the attention detection module 716 recognizes the eye gaze behavior of the user. At operation 1316, the attention detection module 716 extracts the eye gaze features from the video input. Referring to FIG. 13C, at operation 1318, the video processing module 704 extracts the relevant features from the video input. At operation 1320, the video processing module 704 classifies the relevant features for attention detection.

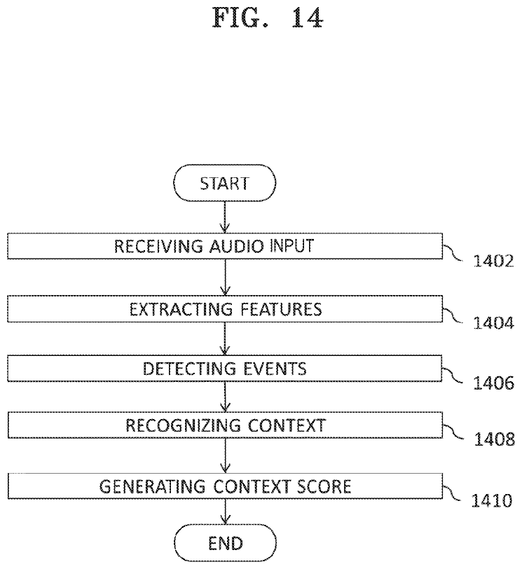

FIG. 14 is a flowchart illustrating a method for generating context score, according to an embodiment of the disclosure.

At operation 1402, the audio processing module 702 receives the audio input which is the audio input signal. At operation 1404, the audio processing module 702 extracts features from the audio input. At operation 1406, the audio processing module 702 detects events from the audio input. At operation 1408, the audio processing module 702 recognizes context of the words or sentences spoken by the user based on the audio input. At operation 1410, the audio processing module 702 generates a context score based on the determined context.

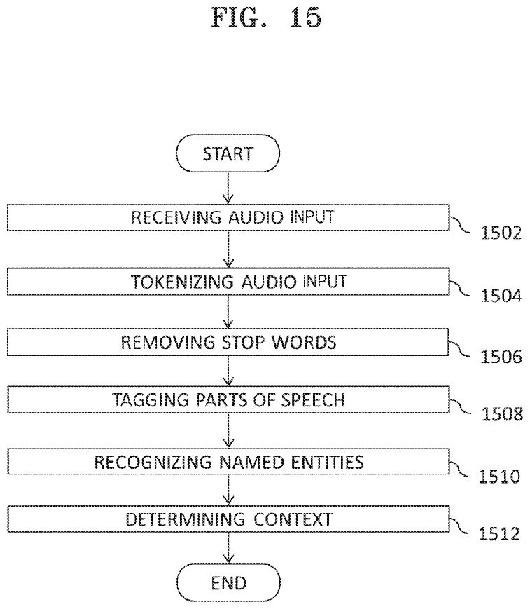

FIG. 15 is a flowchart illustrating a method for determining context, according to an embodiment of the disclosure.

At operation 1502, the verbal cues generation module 712 receives the audio input which is the audio input signal. At operation 1504, the verbal cues generation module 712 tokenizes the received audio input signal. The verbal cues generation module 712 extracts individual words from the sentences included in the audio input signal. After the sentences have been broken into tokens, the verbal cues generation module 712 derives the meaning of the tokens. That is, the verbal cues generation module 712 splits the sentences into smaller parts which makes the processing easier. At operation 1506, the verbal cues generation module 712 removes predetermined words which are called stop words. It is observed that there are certain words in sentences which are not meaningful and are used just for the grammatical purposes, such as “is,” “a,” “the,” etc. Such words may be unnecessary for determining contexts and might not provide any semantic meaning to the sentence. Therefore, the verbal cues generation module 712 may make the tokens concise by removing such stop words. At operation 1508, the verbal cues generation module 712 tags the parts of speech. That is, a tag is assigned to every word of the sentence or the tokens. The tag can be “noun,” “verb,” etc. which gives information about the corresponding word.

At operation 1510, the verbal cues generation module 712 recognizes the named entities. The named entity recognition is a part of information extraction where the entities from the text are categorized into predefined categories such as name of persons, quantity of the names, expression of the names, etc. The named entity recognition includes two parts—detection of the names and classification of the names. At operation 1512, the verbal cues generation module 712 determines the context of the user's speech.

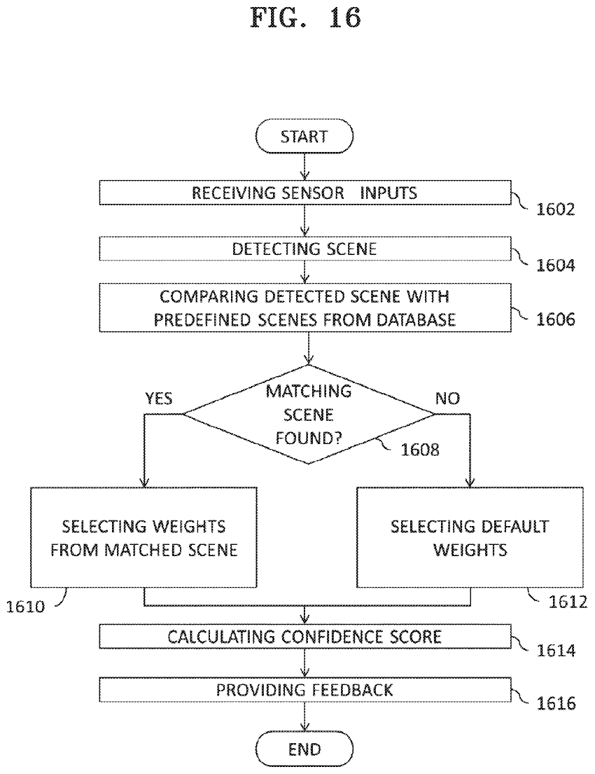

FIG. 16 is a flowchart illustrating a method for calculating confidence score and providing feedback, according to an embodiment of the disclosure.

At operation 1602, the interruption detection system 404 receives the sensor inputs from the sensors 608 of the user device 402. At operation 1604, the interruption detection system 404 detects the scene. At operation 1606, the interruption detection system 404 compares the detected scene with predefined scenes stored in the memory. At operation 1608, the interruption detection system 404 determines whether there is any matching scene with the detected scene. At operation 1608, if the interruption detection system 404 determines that there is a matching scene for the determined scene, the feedback module 424 executes the action of step 1610. At operation 1610, the interruption detection system 404 selects weights from the database.

At operation 1608, if the interruption detection system 404 determines that there is no matching scene for the determined scene, the feedback module 424 executes operation 1612. At operation 1612, the interruption detection system 404 selects the default weights for the scene. At operation 1614, the interruption detection system 404 calculates the confidence score. At operation 1616, the feedback module 424 provides feedback to the confidence score calculator module 422.

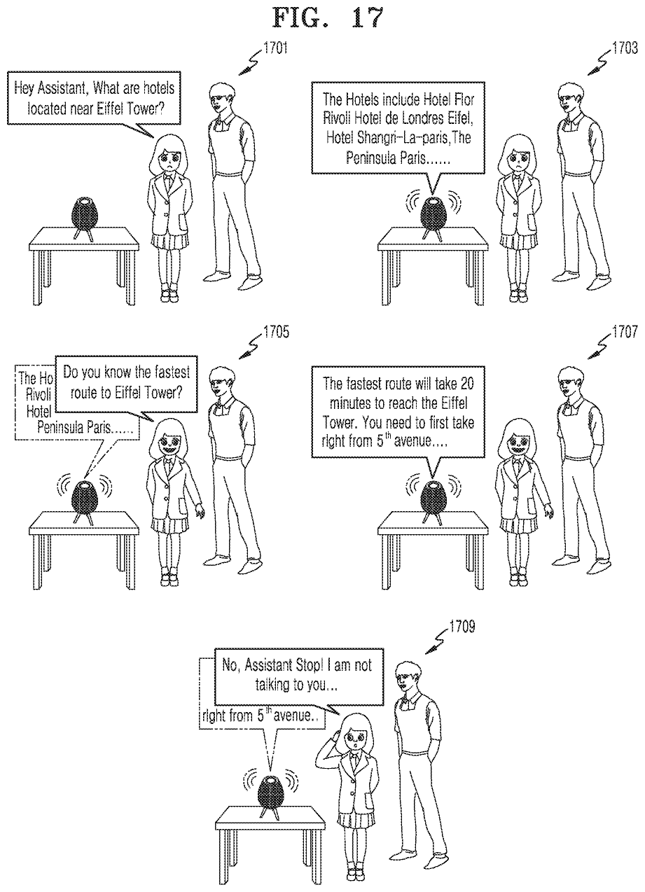

FIG. 17 illustrates interactions between a user and a virtual assistant, according to an embodiment of the disclosure.

In operation 1701, the user asks a query to the virtual assistant. In operation 1703, the virtual assistant replies to the query.

In operation 1705, the user asks a question to the other person. In operation 1707, the virtual assistant misunderstands that the question is directed towards itself and hence, responds to the question.

In operation 1709, the user provides feedback to the virtual assistant to indicate that the question was not directed towards the virtual assistant.

The virtual assistant receives the feedback from the user and updates the weights of the scenes accordingly, thereby improving the efficiency of detection of interrupts in real-time.

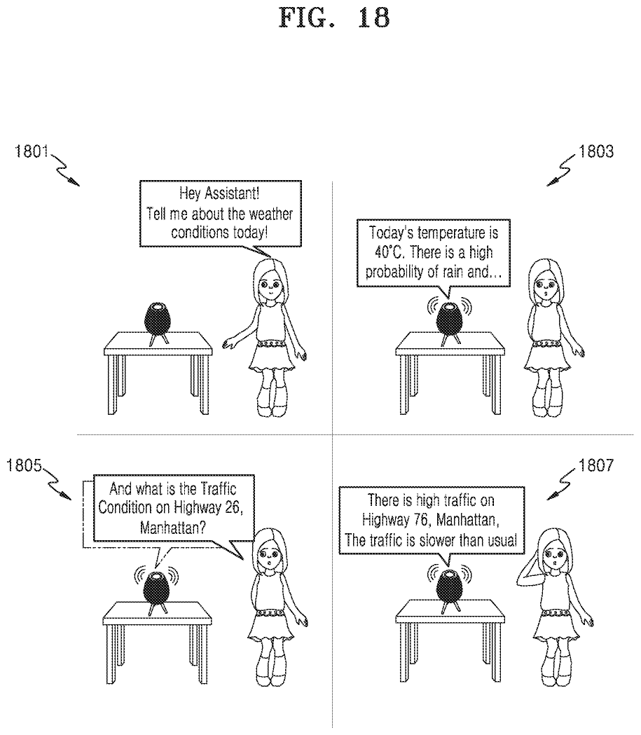

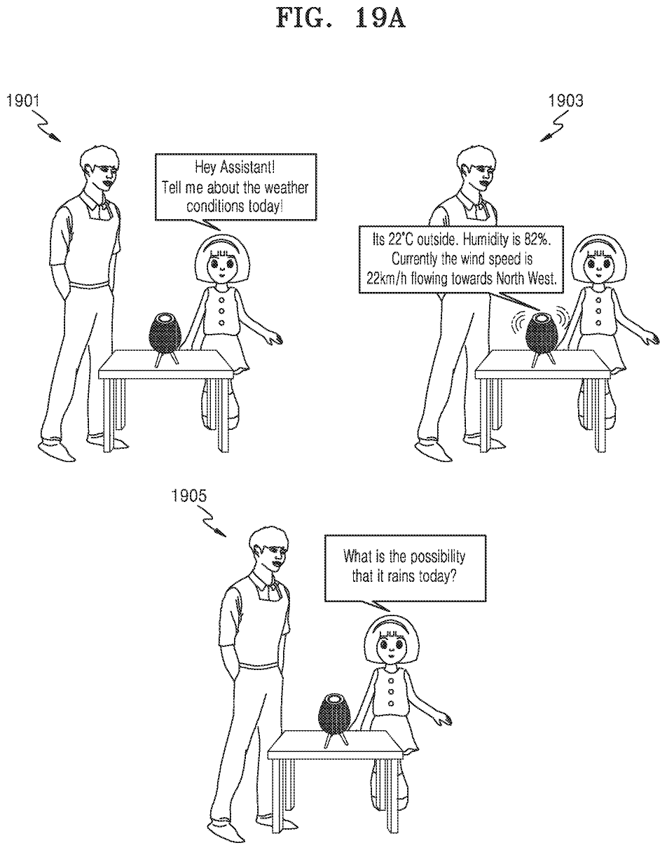

FIG. 18 illustrates interactions between a user and a virtual assistant, according to an embodiment of the disclosure.

In an embodiment, the user asks a first question to the virtual assistant regarding the weather conditions in operation 1801. The virtual assistant provides the answer to the first question, in operation 1803. The user interrupted the answer of the virtual assistant and asks a second question of “What is the traffic condition on Highway 76, Manhattan?” in operation 1805. The virtual assistant calculates the confidence score and identifies that the second question is directed towards the virtual assistant. Therefore, the virtual assistant stops the previous answer and generates and provides an answer to the second question in operation 1807.

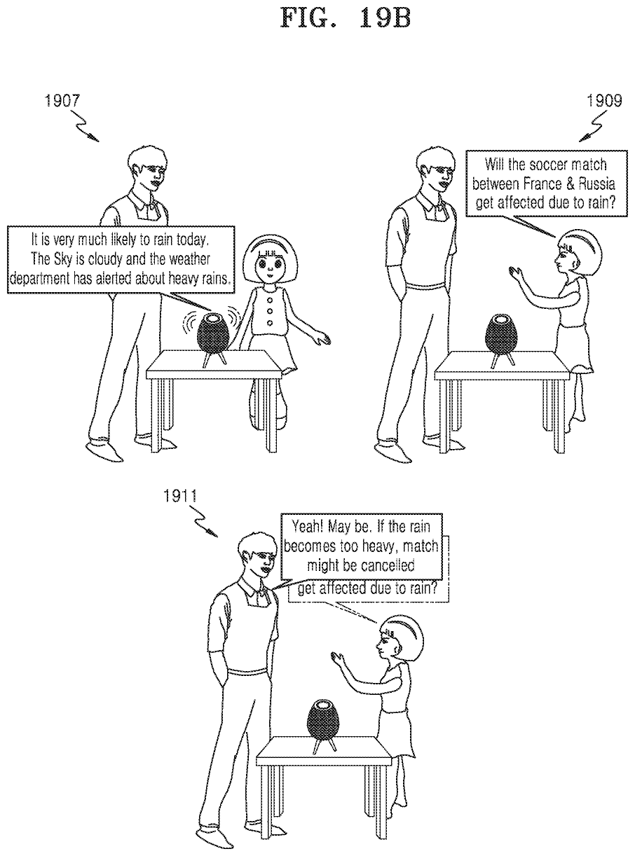

FIG. 19A and FIG. 19B illustrate interactions between a user and a virtual assistant, according to an embodiment of the disclosure.

Referring to FIG. 19A, in operation 1901, the user asks a first question to the virtual assistant. In operation 1903, the virtual assistant answers the first question. In operation 1905, the user asks a second question to the virtual assistant.

Referring to FIG. 19B, in operation 1907, the virtual assistant answers the second question. In operation 1909, the user asks a third question to the other person nearby. In operation 1911, based on the difference in the context of the third question and the previous two questions, the virtual assistant determines that the third question is not directed towards the virtual assistant. Hence, the virtual assistant does not answer the third question in operation 1911.

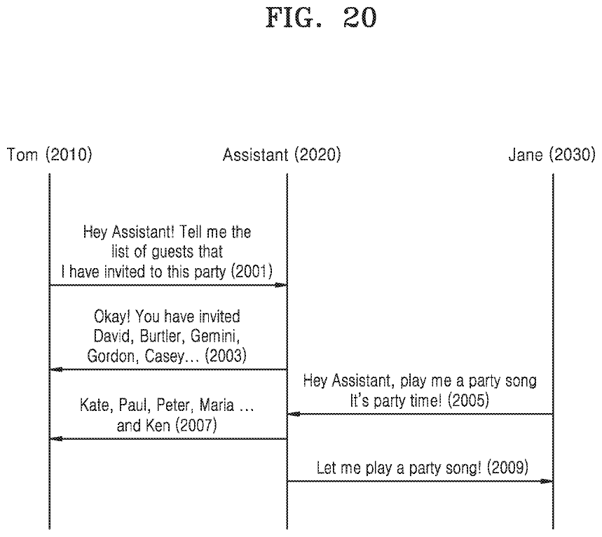

FIG. 20 is a sequence diagram illustrating interactions between a plurality of users and a virtual assistant in accordance with an embodiment of the disclosure.

In operation 2001, a first user—Tom—2010 asks a first question—“Tell me the list of guests that I have invited to this party”—to the virtual assistant 2020. In operation 2003, the virtual assistant 2020 provides an answer—“Okay! You have invited David, Burtler, Gemini, Gordon, Casey . . . ”—to the first question. In operation 2005, a second user—Jane—2030 asks a second question to the virtual assistant 2020. In operation 2007, the virtual assistant 2020 determines that the priority of the first question is greater than the priority of the second question. Hence, the virtual assistant 2020 completes answering to the first question first and thereafter provides a response to the second question. In operation 2009, the virtual assistant responds to the second question, accordingly.

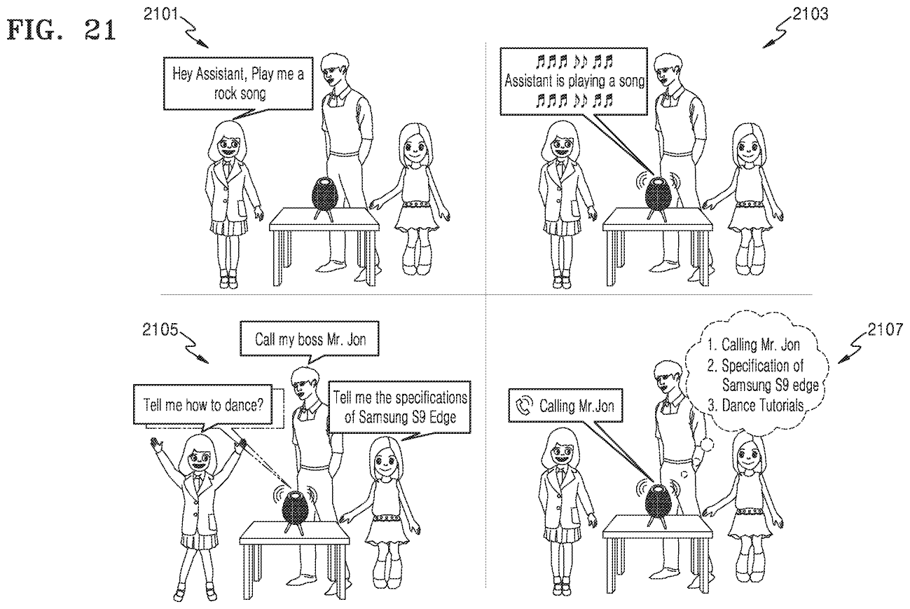

FIG. 21 illustrates interactions between a user and a virtual assistant, according to an embodiment of the disclosure.

In operation 2101, a first user instructs the virtual assistant to play a song. In operation 2103, the virtual assistant plays a song in response to the user's instruction. In operation 2105, many users provide instructions to the virtual assistant simultaneously. In operation 2107, the virtual assistant responds to the subsequent instructions one by one according to their priorities.

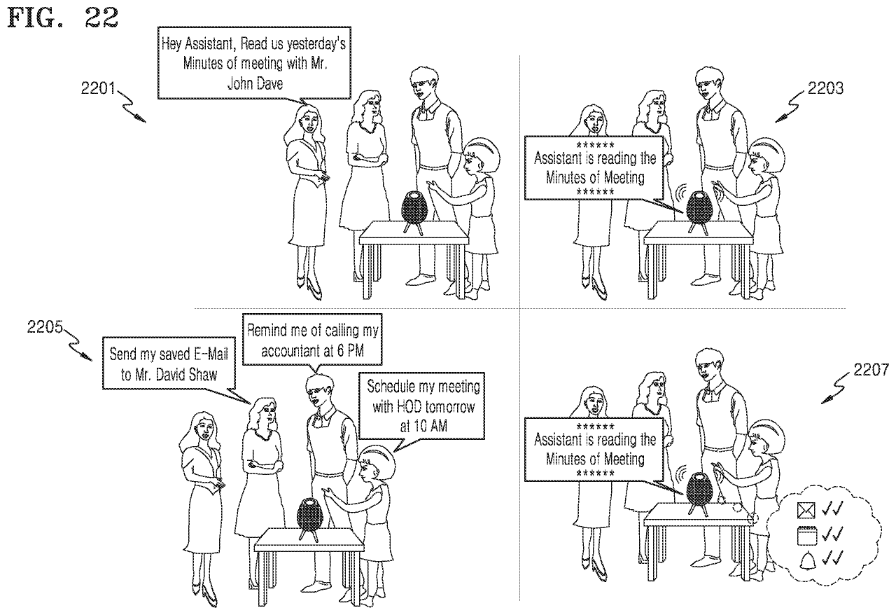

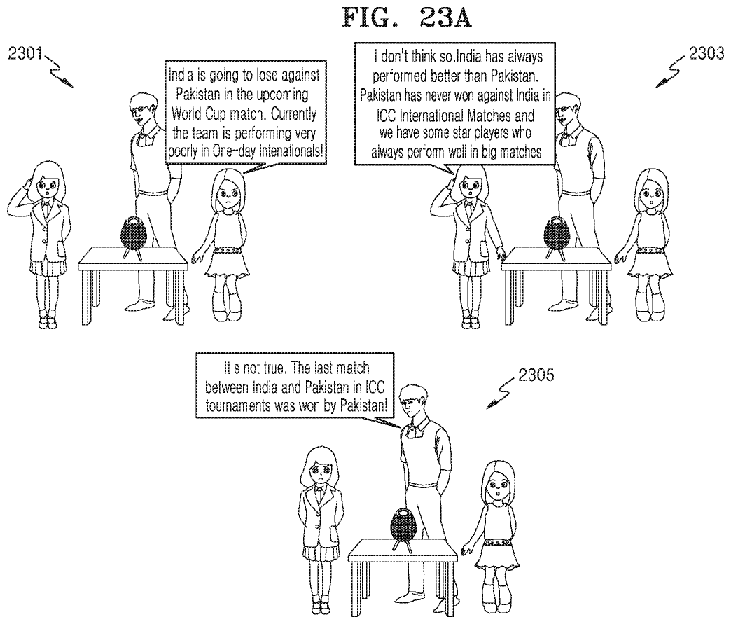

FIG. 22 illustrates interactions between a user and a virtual assistant, according to an embodiment of the disclosure.

In operation 2201, a user instructs the virtual assistant to read minutes of a meeting. In operation 2203, the virtual assistant reads the minutes of the meeting in response to the user's instruction. In operation 2205, the other users provide instructions to the virtual assistant simultaneously or sequentially but with a very short time difference. In operation 2207, the virtual assistant executes the tasks instructed by the other users in background or internally while still reading the minutes of the meeting.

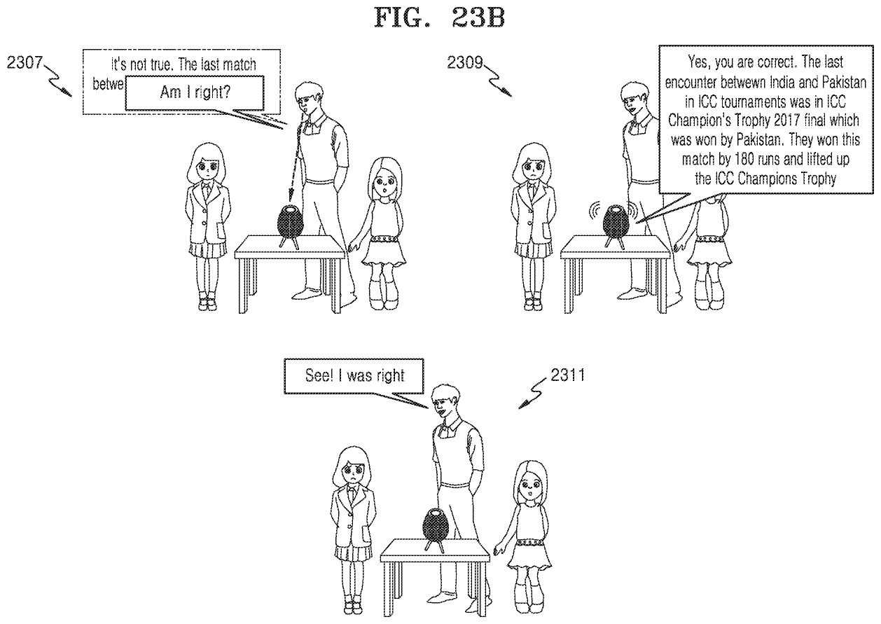

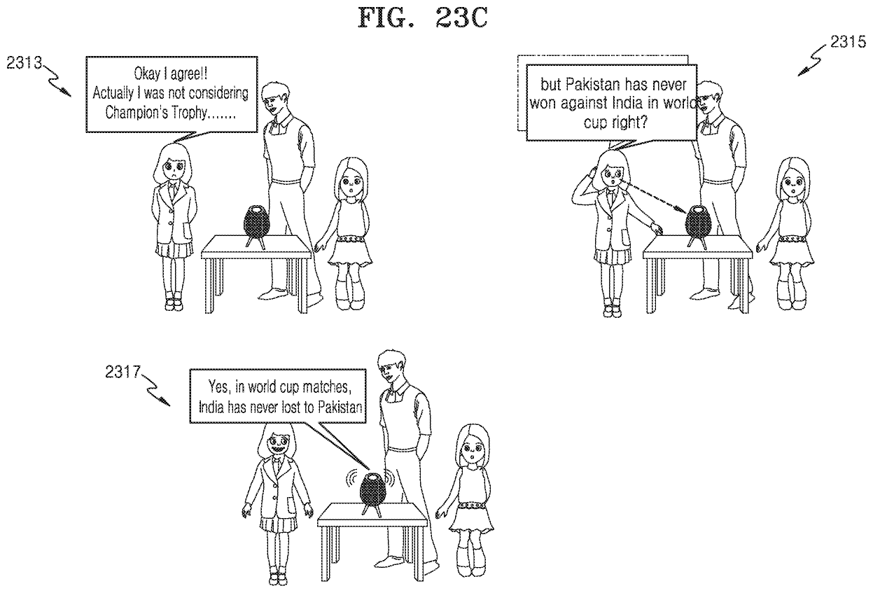

FIG. 23A, FIG. 23B, and FIG. 23C illustrate interactions between a user and a virtual assistant, according to an embodiment of the disclosure.

Referring to FIG. 23A, three users are having a discussion in operations 2301, 2303, and 2305. Referring to FIG. 23B, one of the users asks a question to the virtual assistant regarding the previous discussion in operation 2307 and the virtual assistant provides a relevant answer based on the context of the users' discussion in operation 2309. In operation 2311, the users may reach a conclusion based on the answer provided from the virtual assistant. Referring to FIG. 23C, another user asks a question to the virtual assistant in continuation to the previous question in operations 2313 and 2315 and the virtual assistant provides an answer based on the context of the previous questions and answers, and the previous discussion in operation 2317.

Advantageously, the interruption detection system of the disclosure facilitates a more natural interaction between the user and the virtual assistant. In that, the user does not need to use wake/stop words to interrupt the virtual assistant.

The interruption detection system of the disclosure provides a continuous conversation between the user and the virtual assistant. In that, the virtual assistant is capable of distinguishing between the user talking to the virtual assistant and the user talking to other users.

The interruption detection system of the disclosure profiles the users and provides output based on the user profiles.

The interruption detection system of the disclosure enables the virtual assistant to operate as a fact provider in group discussions.

The interruption detection system of the disclosure enables the virtual assistant to multi-task based on priorities of the users, priorities of the tasks, context of the information, etc.

It should be noted that the description merely illustrates the principles of the disclosure. It will thus be appreciated that those skilled in the art will be able to devise various arrangements that, although not explicitly described herein, embody the principles of the disclosure.

Furthermore, all examples recited herein are principally intended expressly to be only for explanatory purposes to help the reader in understanding the principles of the disclosure and the concepts contributed by the inventors to furthering the art and are to be construed as being without limitation to such specifically recited examples and conditions.

While specific language has been used to describe the disclosure, any limitations arising on account thereto, are not intended. As would be apparent to a person skilled in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method of detecting an instruction from a user, the method comprising:
receiving, from the user of a user device, an audio input;
extracting a non-verbal audio cue or a verbal audio cue based on the audio input;
calculating a confidence score based on the non-verbal audio cue or the verbal audio cue; and
detecting the audio input as the instruction based on the confidence score exceeding a predetermined value.

2. The method of claim 1, wherein the non-verbal audio cue includes at least one of a pitch of the audio input, an intensity of the audio input, an abrupt change in the intensity of the audio input, or an intensity localization of the audio input.

3. The method of claim 1, wherein the verbal audio cue includes at least one of a word, a sentence, a context of the word or the sentence, or a meaning of the word or the sentence.

4. The method of claim 1, further comprising:
receiving a video input;
extracting a video cue based on the video input;
calculating the confidence score based on the video cue; and
detecting the audio input or the video input as the instruction based on the confidence score exceeding the predetermined value.

5. The method of claim 4, wherein video cue includes at least one of a gesture of the user, a movement of the user, an attentiveness of the user, an eye gaze of the user, a distance between the user and the user device, or a presence of another user in a vicinity of the user device.

6. The method of claim 1, further comprising:
executing a task corresponding to the instruction.

7. The method of claim 6, further comprising:
receiving a second audio input during execution of the task;
extracting a second non-verbal audio cue or a second verbal audio cue based on the second audio input;
determining that the instruction is an intentional instruction based on the second non-verbal audio cue or the second verbal audio cue; and
updating the confidence score based on determining that the instruction is the intentional instruction.

8. The method of claim 1, further comprising:
detecting a plurality of audio inputs from a plurality of users;
extracting a plurality of verbal audio cues or a plurality of non-verbal audio data corresponding to each of the plurality of users;
calculating a plurality of confidence scores corresponding to the each of the plurality of users; and
detecting a plurality of instructions corresponding to the plurality of confidence scores.

9. The method of claim 8, further comprising:
allocating respective priorities to the plurality of instructions; and
executing a plurality of tasks corresponding to the plurality of instructions based on the respective priorities.

10. The method of claim 1, further comprising:
extracting verbal information from the audio input;
determining a context of the verbal information; and
transmitting the context of the verbal information as the verbal audio cue.

11. An apparatus for detecting an instruction from a user, the apparatus comprising:
a sensor configured to receive, from a user, an audio input; and
a processor configured to:
extract a non-verbal audio cue or a verbal audio cue based on the audio input;
calculate a confidence score based on the non-verbal audio cue or the verbal audio cue; and
detect the audio input as the instruction when the confidence score exceeds a predetermined value.

12. The apparatus of claim 11, wherein the non-verbal audio cue includes at least one of a pitch of the audio input, an intensity of the audio input, an abrupt change in the intensity of the audio input, or an intensity localization of the audio input.

13. The apparatus of claim 11, wherein the verbal audio cue includes at least one of a word, a sentence, a context of the word or the sentence, or a meaning of the word or the sentence.

14. The apparatus of claim 11, further comprising:
a second sensor configured to receive a video input from the user,
wherein the processor is further configured to:
extract a video cue based on the video input;
calculate the confidence score based on the video cue; and
detect the audio input or the video input as the instruction based on the confidence score exceeding the predetermined value.

15. The apparatus of claim 14, wherein the video cue includes at least one of a gesture of the user, a movement of the user, an attentiveness of the user, an eye gaze of the user, a distance between the user and the apparatus, or a presence of another user in a vicinity of the apparatus.

16. The apparatus of claim 11, wherein the processor is further configured to execute a task corresponding to the instruction.

17. The apparatus of claim 16, wherein the sensor is further configured to receive a second audio input during execution of the task, and
wherein the processor is further configured to:
extract a second non-verbal audio cue or a second verbal audio cue based on the second audio input;
determine that the instruction is an intentional instruction based on the second non-verbal audio cue or the second verbal audio cue; and
update the confidence score based on determining that the instruction is the intentional instruction.

18. The apparatus of claim 11, wherein the sensor is further configured to detect a plurality of audio inputs from a plurality of users;
extract a plurality of verbal audio cues or a plurality of non-verbal audio cues corresponding to each of the plurality of users;
calculate a plurality of confidence scores corresponding to the each of the plurality of users; and
detect a plurality of instructions corresponding to the plurality of confidence scores.

19. The apparatus of claim 18, wherein the processor is further configured to:
allocate respective priorities to the plurality of instructions; and
execute a plurality of tasks corresponding to the plurality of instructions based on the respective priorities.

20. The apparatus of claim 11, wherein the processor is further configured to extract verbal information from the audio input;
determine a context of the verbal information; and
transmit the context of the verbal information as the verbal audio cue.
